(19) United States
(12) Patent Application Publication
(10) Pub. No.: US 2006/0103039 A1
(43) Pub. Date: May 18, 2006

(54) Heat shrink device and method

(76) Inventors: Jeff L. Shields, Austin, TX (US); Larry R. Cox, Austin, TX (US); Edward B. Lurie, Round Rock, TX (US)

Correspondence Address: 3M INNOVATIVE PROPERTIES COMPANY, PO BOX 33427, ST. PAUL, MN, 55133-3427, US

(21) Appl. No.: 10/988,962

(22) Filed: Nov. 15, 2004

(51) Int. Cl. B29D 11/00

(52) U.S. Cl. 264/1.25; 264/230; 425/393

(57) ABSTRACT

A device for contracting a pre-expanded polymer material comprises a base comprising a thermally conductive material. The device further comprises a heat transfer body coupled to the base, where the heat transfer body comprises a thermally conductive material, and where the heat transfer body includes a trough configured to receive and transfer heat to a pre-expanded polymer material disposed in the trough. Through the use of the activating/contacting device, a field technician can utilize a portable oven as a heat source, and avoid the need to use a conventional hot air gun or heat ring. In addition, the activating/contacting device can rapidly contract the heat shrink material over an optical fiber cable and connector portion, e.g., in about 2-20 seconds.

### BACKGROUND OF THE INVENTION

1. Field of the Invention

The present invention is directed to a device and method for activating or contracting heat shrink tubing. More specifically, the present invention is directed to a device and method for activating or contracting heat shrink tubing during the field termination of optical fiber connectors.

2. Related Art

Mechanical optical fiber connectors for the telecommunications industry are known. In recent years, an emphasis has been placed on the use of small form factor (SFF) optical fiber connectors. For example, LC (“Lucent Connectors”) optical-type connectors have been described in U.S. Pat. Nos. 5,481,634; 5,719,977; and 6,318,903. These connectors are used for joining optical fiber segments at their ends and for connecting optical fiber cables to active and passive devices. The LC form factor is about 50% smaller than the form factors for other conventional optical connectors, such as ST, FC, and SC, which can be referred to as large form factor (LFF) connectors.

However, commercially available LC connectors are not well suited for field installations. Conventional adhesive materials include thermal, anaerobic or UV curing adhesives as well as the use of two-part epoxies and acrylates. For example, LC connectors typically use epoxy-based resins (e.g., two part epoxies) for fiber retention within the ferrule portion of the connector. These epoxies require about 10 to 15 minutes to heat cure after application. Once set, the fiber cannot be removed from the ferrule without breaking the fiber, thus making resetting of the optical fiber in the ferrule impractical.

The use of pre-expanded polymer material (commonly referred to as “heat shrink” tubing) is also known for electrical and cable applications. Conventionally, heat shrink tubing is activated through the use of high temperature air guns or heat rings.

### SUMMARY OF THE INVENTION

According to a first aspect of the present invention, a device for contracting a pre-expanded polymer material comprises a base comprising a thermally conductive material. The device further comprises a heat transfer body coupled to the base, where the heat transfer body comprises a thermally conductive material, and where the heat transfer body includes a trough configured to receive and transfer heat to a pre-expanded polymer material disposed in the trough. In a preferred aspect, the base has a shape that is receivable in a portable oven port.

According to another embodiment, a system for activating a pre-expanded polymer material comprises the contracting device described above. The system further includes a heat source to apply heat to the contracting device. In a preferred aspect, the heat source comprises a portable field oven having at least one oven port.

According to another embodiment, a method for contracting a pre-expanded polymer material comprises providing a heat source and the contracting device described above. Heat is transferred from the heat source to the base of the contracting device. fiber optic cable comprising a pre expanded polymer material is disposed in the trough, where the trough applies heat to the fiber optic cable. The fiber optic cable is then removed from the trough. In a preferred aspect, the heat source comprises a portable field oven having at least one oven port.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIGS. 1A-1C show isometric views of an exemplary activating/contracting device for heat shrink tubing according to an embodiment of the present invention and components thereof.

FIG. 2 shows an isometric view of an activating/contracting device for heat shrink tubing according to an alternative embodiment of the present invention.

FIGS. 3A and 3B show views of an exemplary optical fiber connector and fiber cable to be utilized with the exemplary activating/contracting device.

FIG. 4 shows an isometric view of a portion of a field termination procedure utilizing the exemplary activating/contracting device.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

The present invention is directed to a device and method for activating or contracting heat shrink tubing. More specifically, the present invention is directed to a device and method for contracting heat shrink tubing during the field termination of optical fiber connectors.

According to an exemplary embodiment of the present invention, a device for activating or contracting heat shrink tubing about an optical fiber cable can be utilized during the field termination process of an optical fiber connector. In further exemplary embodiments, this activating/contracting device can be utilized with field terminable optical fiber connectors that are pre-loaded with a thermoplastic or thermoset adhesive material. The activating/contracting device can be utilized with a heat source, such as a portable oven, where the base is placed in a field oven receptacle and used to contract or “shrink” a pre-expanded polymeric tubing material (referred to as “heat shrink” tubing), in order to provide further cable retention and axial strain relief. Through the use of the activating/contracting device, a field technician can avoid the need to use a conventional hot air gun or heat ring. In addition, the activating/contracting device can rapidly contract the heat shrink material over an optical fiber cable and connector portion, e.g., in about 2-20 seconds.

The activating/contracting device according to exemplary embodiments can be used in conjunction with the field termination of small form factor (SFF) optical fiber connectors, e.g., LC-type, MU-type, or LX5-type, or large form factor (LFF) optical fiber connectors, e.g., SC, FC, and ST-type, that include a preloaded thermoplastic adhesive. Exemplary devices and methods of field termination can provide for practical field termination of an optical fiber in a SFF or LFF optical fiber connector, as is described in a commonly-owned and co-pending U.S. patent application entitled “Field Termination Apparatus and Method For Small Form Factor Optical Connectors with Thermoplastic Adhesive,” Attorney Docket No. 60093US002, incorporated by reference herein in its entirety.

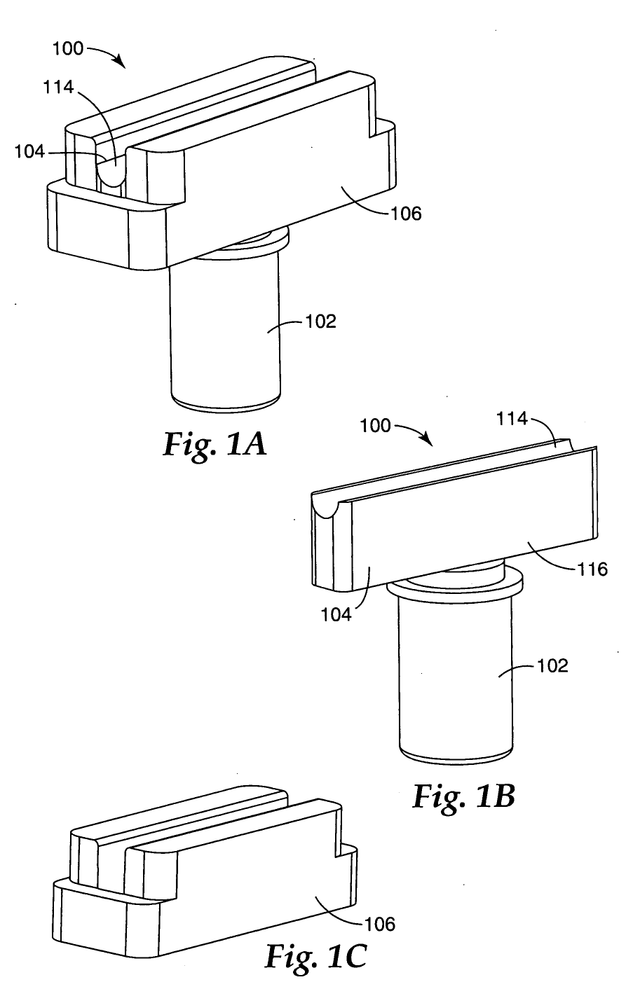

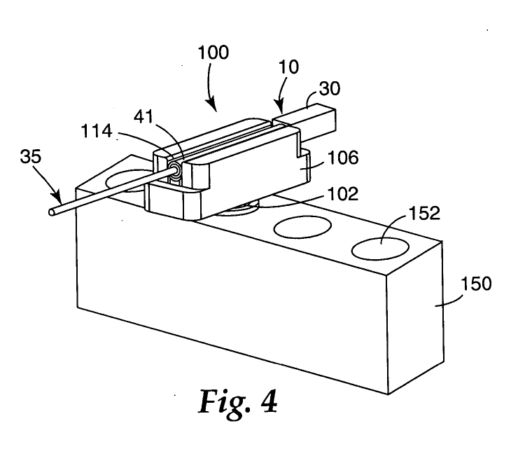

FIGS. 1A-1C show perspective views of an exemplary heat shrink activating/contracting device 100 and components thereof. Device 100 includes a base or post 102. In a preferred aspect, base 102 is configured to be received in a field oven or other heat source (see e.g., field oven 150 shown in FIG. 4). Device 100 further includes a heat transfer element or heat transfer block 104 disposed on the base or post 102. The heat transfer block 104 includes a trough or contoured channel 114, formed in a portion of the heat transfer block 104, to receive and support an optical fiber cable having an expanded heat shrink tube disposed thereon.

The base 102 and heat transfer block 104 can be constructed (e.g., by a machining process) from a material having suitable thermal conductivity, such as a metal (e.g., steel, brass, aluminum, etc.), that permits the rapid transmission of heat from an oven or other heating source to the trough 114. Base 102 and heat transfer block 104 can be formed as a single integral structure from the same thermally conductive material, such as by machining a one piece material. Alternatively, base 102 and heat transfer block 104 can be constructed separately, then attached or coupled by a conventional technique, such as the use of a fastener, screw, pin, solder, or adhesive, in a manner to permit suitable heat transfer from base 102 to heat transfer block 104 and trough 114. The heat transferred to trough 114 can then cause a heat shrink material mounted in the trough to contract in size about a fiber optical cable and fiber optic connector portion mounted thereon (see e.g., FIGS. 3A, 3B, and 4).

Base 102 can be formed as a cylinder (hollow or solid) or any other suitable shape configured to be received in a field oven receptacle. In an exemplary embodiment, base 102 can include a groove or receptacle (not shown) disposed on an outer surface thereof to allow a field technician to grip the device with a suitable tool, such as the tool described in such as that described in a commonly owned, copending U.S. patent application entitled “Device for Holding Field Termination Load Adapter For Optical Connectors” (Attorney Docket No. 60109US002), incorporated by reference herein in its entirety.

The heat transfer element or heat transfer block 104 can also have any convenient shape, such as a rectangular block. The trough 114 can be formed as a contoured channel, groove or elongated well of sufficient length to support a portion of an optical fiber cable. For example, as shown in FIG. 1B, trough 114 can be formed as a groove or contoured channel having an open, semi-cylindrical shape, or other shape (such as a V-shaped groove). The shape or size of trough 114 can be configured to accept various sizes of heat shrink tubing and/or optical fiber cable jacket diameters. In a preferred aspect, the length of trough 114 can be configured to support a standard length of heat shrink tubing for an optical fiber cabling application (e.g., about 0.5″ to about 3″).

In addition, device 100 can (optionally) further include a cover 106, such as shown in FIG. 1C, that slidably fits over an outer surface 116 of heat transfer block 104. Cover 106 be shaped to cover a substantial portion of exposed surfaces of heat transfer block 104, while leaving trough 114 open to the reception of an optical fiber cable having a heat shrink tubing mounted thereon. For example, cover 106 can include an opening (not shown) in a bottom portion to slidably mount over heat transfer block 104. Cover 106 can be constructed from a substantially insulating material, such as a TEFLON™ material, a rubber-based material, a foam based material, or other similar material capable of withstanding temperatures of about 100° C. to about 280° C. (depending on the output temperature of the heat source). Cover 106 can be utilized to provide at least some thermal insulation, so that a field technician will not be burned should an inadvertent touching of device 100 occur during the heat shrink contraction process.

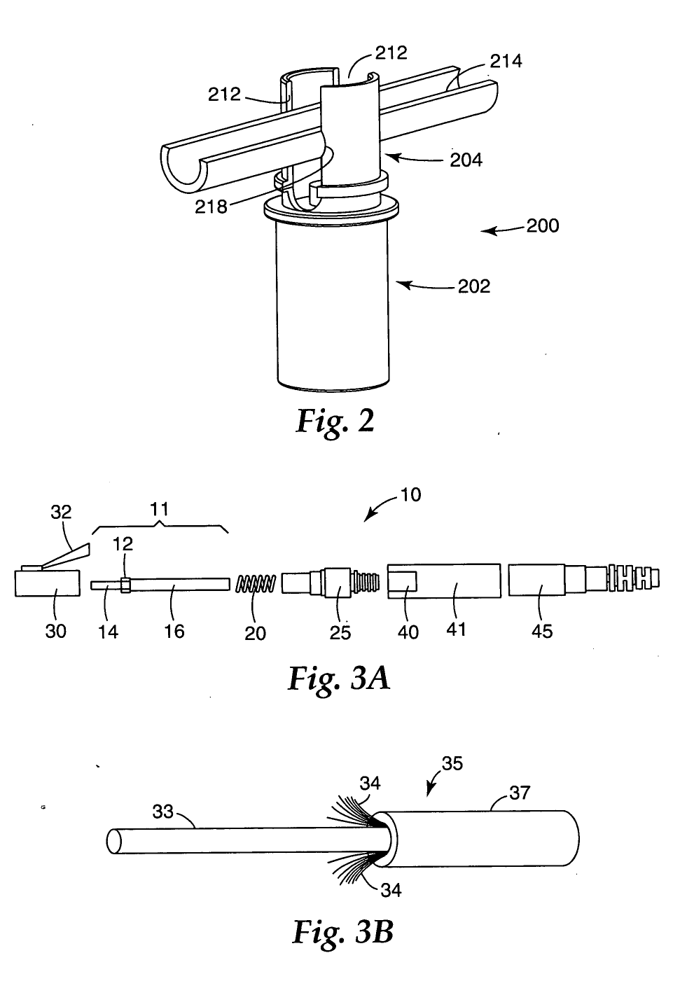

As would be understood by one of ordinary skill in the art given the present description, device 100 can be constructed in alternative ways. For example, as shown in FIG. 2, a heat shrink activating/contracting device 200 can be constructed to include a base or post 202, which is configured to be received in a portable heat source or oven port. Device 200 can further include a trough holder 204, which can support a separate trough structure 214. Trough holder portion 204 can include one or more slots 212, in which trough 214 can be placed. In this alternative embodiment, slots 212 can include indents 218 to more stably support trough structure 214. In this alternative embodiment, base 202, trough holder 204, and trough structure 214 can be constructed (e.g., by a machining process) from a material having suitable thermal conductivity, such as a metal (e.g., brass, aluminum, etc.), that permits the rapid transmission of heat from an oven or other heating source to the trough 214. The shape of trough structure 214 can be configured to accept various sizes of heat shrink tubing and/or optical fiber cable jacket diameters, similar to that described above.

As mentioned above, the activating/contracting device of the present invention can be used in conjunction with the field termination of SFF and LFF optical fiber connectors. For example, FIG. 3A shows an exemplary optical fiber connector, here an LC-type optical fiber connector 10, in an exploded view, that can be utilized in accordance with exemplary embodiments of the present invention. This description is not meant to be limiting, as other types of SFF connectors and LFF connectors can also be utilized.

Exemplary connector 10 includes a housing 30 having a latching arm 32 and an axial or central bore to receive ferrule assembly 11. Housing 30 and latching arm 32 are formed or molded to be received into an LC receptacle. The construction of an exemplary LC-type optical connector is further described in commonly-owned and co-pending U.S. patent application Ser. No. 10/811,437, incorporated by reference herein in its entirety.

LC housing 30 can be formed or molded from a high temperature material, such as a high temperature polymer (e.g., plastic) material. The high temperature polymer material is capable of withstanding temperatures of at least 190° C., without deformation of the body dimensions, such as described in commonly-owned and co-pending U.S. patent application Ser. No. 10/811,437, incorporated by reference above.

Connector 10 further includes a ferrule assembly 11. The ferrule assembly can be designed to include a ferrule 14, a collar 12 and a barrel 16. Collar 12 can be used as a flange to provide resistance against spring 20, to maintain the position of the ferrule assembly within housing 30. Ferrule 14 can be formed from a ceramic, glass, plastic, or metal material to support an optical fiber inserted therein. Barrel 16 can be short or elongated, and can be formed from (e.g., by machining) a thermally conductive material, such as a metal or high temperature polymer, or can be a press fit assembly to the ferrule collar or a threaded assembly, or can comprise an injection-molded, integral material.

According to exemplary embodiments, the ferrule assembly, in particular the ferrule 14 and at least a portion of barrel 16 are preloaded with an adhesive material. In a preferred aspect, the adhesive material is a thermoplastic adhesive that can rapidly soften at a sufficient elevated temperature and that can rapidly harden when exposed to ambient (e.g., room) temperature. For example, the thermoplastic adhesive utilized can be a thermoplastic resin, such as described in U.S. Pat. No. 4,984,865, incorporated by reference herein in its entirety. In addition, the thermoplastic adhesive can be an ultra high temperature (UHT) thermoplastic adhesive material which provides a high softening point and that is capable of satisfying environmentally stringent Telcordia GR-326 specifications. In one aspect, reduced assembly times in field termination applications can be accomplished. Other suitable adhesives and the pre-loading of an exemplary LC-type optical connector are further described in commonly-owned and co-pending U.S. patent application Ser. No. 10/811,437, incorporated by reference above.

Connector 10 can further include an insert or connector body 25 that provides for the retention of the ferrule assembly 11 and spring 20 within housing 30. Connector body 25 can slide over the ferrule assembly and can be secured in place by the outer connector housing 30. A crimp ring 40 can provide additional axial retention and strain relief for the strength members of the optical cable and cable jacket (see FIG. 3B) by crimping the strength members and the rear portion of connector body 25.

Further, pre-shrunk heat shrink tubing 41 can be disposed on at least a portion of crimp ring 40 to provide additional cable retention and axial strain relief during the field termination process, especially at the interface point between the connector housing/body and the optical fiber cable. Exemplary heat shrink tubing is commercially available from many vendors, such as heatshrink.com™, of Ogden, Utah. After crimping of the crimp ring 40, using e.g., a conventional crimping tool, the heat shrink tubing 41 can then be contracted. After contraction of the heat shrink tubing, a boot 45 can be disposed over the heat shrink tubing 41, which provides additional diameter to the fiber cable, to further protect the optical fiber cable from bend related stress losses.

An exemplary optical fiber cable 35 to be inserted in connector 10 is shown in FIG. 3B. The optical fiber cable 35 can comprise an optical fiber portion 33 (which can include a fiber core, cladding, and/or buffer coating layers), a fiber cable jacket 37, and fiber cable strength members 34 (such as formed from a Kevlar material) disposed between the fiber 33 and cable jacket 37. A stripped optical fiber portion 33 can be inserted through the barrel 16, such that the fiber end slightly protrudes from or is coincident or coplanar with the end face of ferrule 14. The thermoplastic material, also referred to as a “hot melt” adhesive or ultra high temperature (UHT) hot melt adhesive, pre-loaded into the ferrule assembly, can be heated in the field as described in a commonly-owned and co-pending U.S. patent application entitled “Field Termination Apparatus and Method For Small Form Factor Optical Connectors with Thermoplastic Adhesive,” Attorney Docket No. 60093US002, incorporated by reference above.

A portion of the field termination procedure utilizing exemplary activating/contracting device 100 is illustrated with reference to FIG. 4. After an optical fiber is terminated in connector 10, the optical fiber cable 35 can be placed in activating device 100 by a field technician. In an exemplary embodiment, an activating device 100 (such as is described above with respect to FIGS. 1A-1C), which includes a base 102, a heating block 104, and (optionally) a cover 106, is placed in an oven port 152 of a heated field oven 150. Heat from the oven 150 immediately heats base section 102 and can be distributed to the heating block 104 and trough 114 of the activating/contracting device 100. Oven 150 is preferably portable and can provide adjustable oven port temperatures of at least 200° C. Exemplary portable ovens are supplied by Kitco, located in Virginia.

In this exemplary embodiment, a crimp ring 40, having heat shrink tubing 41 disposed thereon, is positioned onto a fiber receiving end of the connector, such as a rear portion of connector body 25 (see FIGS. 3A and 3B). The crimping ring is then crimped onto the fiber cable strength members and connector body using a conventional crimping tool. The portion of the fiber cable 35 that includes crimp ring 40 (already crimped) and heat shrink 41 can be placed in the heated trough or channel 114 by the field technician. Preferably, the connector housing will be positioned outside the trough 114, such as is illustrated in FIG. 4, to reduce direct heating of the connector housing 30. After a period of 2-20 seconds, preferably about 2-10 seconds, depending on oven temperature, the heat shrink 41 will contract about the fiber cable jacket 37 adjacent to and/or near the crimp ring 40, and the back end of the connector 10. The fiber cable 35 can then be removed from the trough 114. After removal, the boot 45 can be slid into place over the heatshrink 41, and the inserted fiber can be field polished to remove excess adhesive and to provide a suitably polished fiber end face. Such polishing techniques are described in commonly pending and co-owned U.S. patent application entitled “Fiber Polishing Apparatus and Method For Field Terminable Optical Connectors,” Attorney Docket no. 60095US002, incorporated by reference herein in its entirety and commonly-owned and co-pending U.S. patent application Ser. No. 10/811,437, incorporated above. The above description is not meant to be limiting, as other types of SFF connectors and LFF connectors can be utilized, as well as connectors that use different types of adhesives to set the optical fiber in the fiber connector ferrule.

Thus, according to the exemplary embodiments described above, a field technician can avoid having to use a heat gun or heat rings, which can be costly and can require an additional power source or power cord, and can take up additional space. Also, as an activating/contracting device, such as device 100 or device 200, can support the fiber cable, one or both of the field technician's hands are freed to perform other tasks. In addition, the use of an exemplary activating/contracting device can shorten the field termination time, as the heat shrink can be activated rapidly, in about 2 to about 20 seconds, while at the same time reducing possible exposure of the fiber cable or connector housing to direct heat (such as may be present using a heat gun, which can damage the fiber cable jacket). Further, the possibility of incurring an electrical shock or the possibility of incurring a bum can be reduced through the use of a device, such as device 100.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. A device for contracting a pre-expanded polymer material, comprising:
a base comprising a thermally conductive material; and
a heat transfer body coupled to the base, the heat transfer body comprising a thermally conductive material, wherein the heat transfer body includes a trough configured to receive and transfer heat to the pre-expanded polymer material disposed in the trough.

2. The device of claim 1, wherein the base has a shape that is receivable in an oven port.

3. The device of claim 1, further comprising a cover slidably disposed over at least a portion of an outer surface of the heat transfer body.

4. The device of claim 3, wherein the cover comprises a substantially thermally insulating material.

5. The device of claim 1, wherein the trough has a contoured groove having a semi-cylindrical shape.

6. A system for contracting a pre-expanded polymer material, comprising:
a base comprising a thermally conductive material;
a heat transfer body coupled to the base, the heat transfer body comprising a thermally conductive material, wherein the heat transfer body includes a trough configured to receive and transfer heat to the pre-expanded polymer material disposed in the trough; and
a heat source to transfer heat to the base.

7. The system of claim 6, wherein the base has a shape that is receivable in an oven port.

8. The system of claim 6, wherein the heat source comprises a portable heating oven that includes at least one oven port.

9. The system of claim 6, further comprising a cover slidably disposed over at least a portion of an outer surface of the heat transfer body.

10. The device of claim 9, wherein the cover comprises a substantially thermally insulating material.

11. The device of claim 6, wherein the trough has a contoured groove having a semi-cylindrical shape.

12. A method for contracting a pre-expanded polymer material, comprising:
providing a heat source;
providing a device for contracting the pre-expanded polymer material, the device comprising a base having a thermally conductive material, and a heat transfer body coupled to the base, the heat transfer body comprising a thermally conductive material, wherein the heat transfer body includes a trough configured to receive and transfer heat to the pre-expanded polymer material disposed in the trough;
transferring heat from the heat source to the base;
disposing a fiber optic cable having the pre-expanded polymer material in the trough, wherein the trough applies heat to the fiber optic cable; and
removing the fiber optic cable from the trough.

13. The method according to claim 12, wherein the trough applies heat to the pre-expanded polymer material for about 2 seconds to about 20 seconds.

14. The method according to claim 12, wherein the heat source comprises a portable oven having an oven port and the base has a shape that is receivable in the oven port, wherein transferring heat from the heat source to the base comprises placing the base in a heated oven port.
